(19) United States
(12) Patent Application Publication
(10) Pub. No.: US 2006/0194110 A1
(43) Pub. Date: Aug. 31, 2006

(54) Non-aqueous electrolyte secondary battery and charging method thereof

(75) Inventors: Shinya Miyazaki, Tokushima (JP); Nobumichi Nishida, Tokushima (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/355,183

(22) Filed: Feb. 16, 2006

(30) Foreign Application Priority Data
Feb. 21, 2005 (JP) JP2005-043545

(51) Int. Cl. H01M 4/52; H01M 10/44

(52) U.S. Cl. 429/231.3; 429/50

(57) ABSTRACT

A non-aqueous electrolyte secondary battery with excellent cycle characteristics and thermal stability in which the potential of the positive electrode active material ranges from 4.4V to 4.6 V based on lithium, and-charging method therefor are provided, wherein the positive electrode active substance of a non-aqueous electrolyte secondary battery comprises a hexagonal system of lithium-containing transition metal composite oxide formed by adding zirconium, magnesium, and aluminum as foreign elements upon synthesis of lithium cobalt oxide, with zirconium content ranging from 0.01 to 1 mol %, magnesium content ranging from 0.01 to 3 mol %, and aluminum content ranging from 0.01 to 3 mol %, and an Li/Co molar ratio ranging from 1.00 to 1.05.

### BACKGROUND OF THE INVENTION

1. Field of the Invention

The present invention relates to a nonaqueous electrolyte secondary battery comprising a positive electrode active material with a potential ranging from 4.4 to 4.6 V based on lithium and a charging method therefor. In particular, the nonaqueous electrolyte secondary battery of the present invention comprises a positive electrode active material with a potential ranging from 4.4 to 4.6 V based on lithium, produced by using a hexagonal system of lithium-containing transition metal compound oxide formed by adding zirconium, magnesium, and aluminum as foreign elements to lithium cobalt oxide, thereby exhibiting excellent cycle characteristics and thermal stability, and a charging method therefor.

2. Description of Prior Art

Along with the rapid and widespread use of portable electronic equipments, specifications required for batteries used therein have become more and more stringent, and those that are small in size, thinly shaped, yet have high capacity, and exhibit excellent cycle characteristics and stable performance have become particularly desirable. In the field of secondary batteries, non-aqueous electrolyte lithium secondary batteries have been noted for higher energy density compared with batteries of other types such that the market share of non-aqueous lithium electrolyte secondary batteries has remarkably grown.

FIG. 1 is a perspective view along the vertical cross section of a cylindrical non-aqueous electrolyte secondary battery of prior art, whereby a non-aqueous electrolyte secondary battery 10 is manufactured by encasing a spiral electrode 14 consisting of a positive electrode plate 11 and a negative electrode plate 12 which are wound together while interposing a separator 13 therebetween inside a cylindrical battery outer casing 17 made of stainless steel, where the outer casing 17 also serves as a negative electrode terminal after locating insulative plates 15 and 16 above and below the spiral electrode 14, then welding a collector tab 12a of the negative electrode plate 12 to the inner bottom of the battery outer casing 17 and welding a collector tab 11a of the positive electrode plate 11 to the bottom plate portion of a current-shutting seal 18 assembled with a safety device, and thereafter injecting a predetermined non-aqueous electrolyte into the opening of the battery outer casing 17 and then tightly closing the battery outer casing 17 by means of the current-shutting seal 18. This type of non-aqueous electrolyte secondary battery produces excellent effects such as high battery performance and reliability.

The negative electrode active material used in the above-described non-aqueous electrolyte secondary consists of carbonaceous materials such as graphite and amorphous carbon which are generally used because of their excellent properties of high safety by inhibiting the growth of dendrites and initial efficiency, and have satisfactory potential flatness as well as high density while having a discharge potential comparable to that of a lithium metal or lithium alloy.

Further, carbonates, lactones, ethers, esters, etc. are used singly or in combination as non-aqueous solvent for the non-aqueous electrolyte. In particular, carbonates having high dielectric constant and high ionic conductivity are often used to produce the non-aqueous electrolyte.

On the other hand, it is known that a 4 V class non-aqueous electrolyte secondary battery of high energy density can be obtained by using a combination of lithium composite oxide such as LiCoO₂, LiNiO₂, LiMnO₂, LiMn₂O₄, LiFeO₂, etc. as positive electrode active material with a negative electrode comprising a carbon material. Of these lithium composite oxides, LiCoO₂ has often been used because various battery characteristics have been found to excel over others. However, since cobalt is expensive and natural resources are rather limited, efforts have been made to determine whether other transition elements which may yield battery characteristics that are equal to or even exceed those obtained by using cobalt may be substituted, as demand continues to grow for non-aqueous electrolyte secondary batteries with better performance and longer life.

For example, a method of adding foreign elements such as Zr or Mg to LiCoO₂ for the purpose of improving the characteristics of a non-aqueous electrolyte secondary battery using LiCoO₂ as positive electrode active material has been disclosed in JP-A No. H4-319260 (claims, and columns [0006], [0008] to [0011], hereinafter, “Patent Document 1”) and JP-A No. 2004-299975 (claims, and columns [0006] to 00008), hereinafter, “Patent Document 2”). Patent Document 1 discloses a non-aqueous electrolyte secondary battery capable of generating a high voltage and showing excellent charge/discharge characteristics and shelf life characteristics by adding zirconium to LiCoO₂ as positive electrode active material. When zirconium is added to LiCoO₂ as positive electrode active material, the surface of LiCoO₂ particles are stabilized by being covered with zirconium oxide (ZrO₂) or composite oxide of lithium and zirconium (Li₂ZrO₃) and, as a result, a positive electrode active material showing excellent cycle and shelf life characteristics can be obtained without causing decomposing reaction in the electrolyte or destruction of crystals even at high potential. Such effect cannot be obtained by merely mixing LiCoO₂ after burning with zirconium or zirconium compound but is obtained by adding zirconium to a mixture of lithium salt and the cobalt compound and burning them. Patent Document 2 also discloses that by adding not only zirconium (Zr) but also at least one other member such as titanium (Ti) and fluorine (F) as foreign elements to LiCoO₂ as positive electrode active material, the load and cycle characteristics of the non-aqueous electrolyte lithium secondary battery can be improved.

At present, where a lithium-containing transition metal oxide such as lithium cobalt oxide (LiCoO₂) is used as positive electrode active material and a carbon material is used as negative electrode active material such as graphite in a non-aqueous electrolyte secondary battery, the charging voltage achieved ranges from 4.1 to 4.2 V (potential of positive electrode active material is 4.2 to 4.3 V based on lithium). Under such charging condition, only about 50 to 60% of the capacity of the positive electrode is utilized based on theoretical capacity. Accordingly, if the charging voltage can be increased, as much as 70% of the capacity of the positive electrode can be utilized, or higher, relative to the theoretical capacity thereby increasing the capacity and energy density of the battery.

JP-A No. 2002-042813 (claims, and columns [0011] to [0016], hereinafter, “Patent Document 3”), JP-A No. 2004-296098 (claims, hereinafter, “Patent Document 4”), and Electrochemical and Solid-State Letters, 4 (12) A200-A203 (2001) (hereinafter, “Non-Patent Document 1”) also disclose relevant information.

### SUMMARY OF THE INVENTION

However, to increase the battery charging voltage for the purpose of increasing the capacity of the non-aqueous electrolyte secondary battery, two conditions must be achieved, namely, excellent cycle performance at high potential (stability of structure in respect of the positive electrode active material) and high safety (high thermal stability in respect of the positive electrode active material). In one example, where a positive electrode prepared by using lithium cobalt oxide (LiCoO₂) without the addition of metal elements other than cobalt and lithium is charged and discharged at a maximum potential of 4.6 V based on lithium, capacity has been observed to diminish by 5% or more relative to the initial capacity even after charging and discharging for ten cycles and the battery's durability is affected due to continued use. In addition, the thermal stability of the positive electrode remarkably deteriorates while its charging potential increases.

In view of these problems, the present inventors have made various studies to determine how to obtain a positive electrode active material which would render a non-aqueous electrolyte secondary battery capable of attaining high charging voltage more stably and, as a result, have found that a non-aqueous electrolyte secondary battery with excellent cycle characteristics and thermal stability can be obtained if the potential of the positive electrode active material ranges from 4.4 to 4.6 V based on lithium, and which potential can be achieved by using lithium cobalt oxide as positive electrode active material to which foreign elements having a specified composition and crystal structure have been added.

Accordingly, the present invention intends to provide a non-aqueous electrolyte secondary battery using lithium cobalt oxide to which foreign elements have been added as positive electrode active material, with excellent cycle characteristics and thermal stability where the potential of the positive electrode active substance ranges from 4.4 to 4.6 V based on lithium, as well as a charging method therefor.

The foregoing object can be attained in accordance with the following constitution. The first aspect of the invention provides for a non-aqueous electrolyte secondary battery consisting of a positive electrode comprising a positive electrode active material, a negative electrode comprising a negative electrode active material, and a non-aqueous electrolyte containing a non-aqueous solvent and electrolyte salt, in which the positive electrode active material comprises a hexagonal system of lithium-containing transition metal composite oxide, formed by adding zirconium, magnesium, and aluminum as foreign elements to lithium cobalt oxide, with the zirconium content ranging from 0.01 to 1 mol %, the magnesium content ranging from 0.01 to 3 mol %, and the aluminum content ranging from 0.01 to 3 mol %, and an Li/Co molar ratio ranging from 1.00 to 1.05 and the potential of the positive electrode active material ranges from 4.4 V to 4.6 V based on lithium.

In the first aspect of the invention, it is essential to add the three elements of zirconium, magnesium, and aluminum as foreign elements to lithium cobalt oxide. If the amount of zirconium added is less than 0.01 mol %, the intended effect of improving the battery's internal short circuit test result in a charged state cannot be obtained and, if it exceeds 1 mol %, the battery capacity diminishes while heat stability thereof deteriorates, so that the preferred range is from 0.01 to 1 mol %. If the amount of magnesium added is less than 0.01 mol %, the intended effect of improving the battery's thermal stability cannot be obtained and if it exceeds 3 mol %, the battery capacity diminishes so that the preferred range is from 0.01 to 3 mol %. Further, if the amount of aluminum added is less than 0.01 mol %, the intended effect of improving the battery's thermal stability cannot be obtained and if it exceeds 3 mol %, the battery capacity diminishes while thermal stability deteriorates, so that the preferred range is from 0.01 to 3 mol %.

Further, zirconium, magnesium, and aluminum or compounds thereof as foreign elements can not provide the predetermined effect by mixing them with LiCoO₂ after burning. The desired effect can be attained only if they are added to LiCoO₂ before burning.

Further, it is essential that the lithium cobalt oxide to which foreign elements are added is a lithium-containing transition metal composite oxide having a hexagonal system crystal structure with Li/Co molar ratio ranging from 1.00 to 1.05. If the Li/Co molar ratio is less than 1.00, the initial capacity of the battery remarkably diminishes and if the Li/Co molar ratio exceeds 1.05, the charge/discharge cycle capacity retaining ratio at a high potential of 4.4 V or higher based on lithium decreases. Accordingly, to obtain a battery with satisfactory initial capacity and charge/discharge cycle capacity retaining ratio at a high potential of 4.4 V or higher based on lithium, it is necessary to control the Li/Co molar ratio within the range of 1.00 to 1.05.

Further, in the present invention, carbonates, lactones, ethers, esters, etc. can be used as a non-aqueous solvent constituting a non-aqueous solvent system electrolyte (organic solvent) and two or more of these solvents may be used in admixture. Among them, carbonates, lactones, ethers, ketones, and esters are preferred, with the carbonates being more suitable for use.

Specific examples can include, for example, ethylene carbonate (EC), propylene carbonate (PC), butylene carbonate (BC), vinylene carbonate (VC), cyclopentanone, sulfolane, 3-methyl sulfolane, 2,4-dimethyl sulfolane, 3-methyl-1,3-oxazolidine-2-one, dimethyl carbonate (DMC), methyl ethyl carbonate (MEC), diethyl carbonate (DEC), methyl propyl carbonate, methyl butyl carbonate, ethyl propyl carbonate, ethyl butyl carbonate, dipropyl carbonate, γ-butyrolactone, γ-valerolactone, 1,2-dimethoxyethane, tetrahydrofuran, 2-methyl tetrahydrofuran, 1,3-dioxolane, methyl acetate, ethyl acetate, and 1,4-dioxane. In the present invention, an EC-containing solvent mixture is preferably used as a means of enhancing the battery's charge/discharge efficiency. Generally, since cyclocarbonates are easily oxidatively decomposed at a high potential, the EC content of the non-aqueous solvent should preferably be 5 vol % or more and 25 vol % or less.

As solute for the non-aqueous electrolyte of the non-aqueous electrolyte secondary battery of the invention, lithium salts are generally used, examples of which are LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₁)₃, LiC(C₂F₅SO₂)₃, LiAsF₆, LiClO₄, Li₂B₁₀Cl₁₀, and Li₂B₁₂Cl₁₂, and mixtures thereof. Among them, LiPF₆ (lithium hexafluoro phosphate) is preferably used. When the battery is charging at a high charging voltage, aluminum as positive electrode collector tends to dissolve easily, such that the decomposing LiPF₆ forms a coat on the aluminum surface under the presence of LiPF₆, which then suppresses dissolution of the aluminum. Accordingly, the use of LiPF₆ as lithium salt is preferred. The amount of solute to be dissolved in the non-aqueous solvent preferably ranges from 0.5 to 2.0 mol/L.

The second aspect of the invention provides for a non-aqueous electrolyte secondary battery according to the first aspect of the invention, whereby the foreign elements are added by co-precipitation upon synthesis of cobalt carbonate or cobalt hydroxide as starting material for the positive electrode active material.

The third aspect of the invention provides for a non-aqueous electrolyte secondary battery according to the first aspect of the invention, wherein the negative electrode active material comprises a carbonaceous material, such as natural graphite, artificial graphite, carbon black, coke, glass-like carbon, carbon fiber or a kind of burned substance thereof, which can be used singly or in combination by admixture.

The fourth aspect of the invention provides for a non-aqueous electrolyte secondary battery according to the first aspect of the invention, wherein the non-aqueous electrolyte further contains vinylene carbonate ranging from 0.5 to 5 mass %.

The fifth aspect of the invention provides for a method of charging a non-aqueous electrolyte secondary battery comprising a positive electrode formed from a positive electrode active material, a negative electrode formed from a negative electrode active material, a non-aqueous solvent, and an electrolyte salt, in which the positive electrode active material comprises a hexagonal system of lithium-containing transition metal compound oxide formed by adding zirconium ranging from 0.01 to 1 mol %, magnesium-ranging from 0.01 to 3 mol %, and aluminum ranging from 0.01 to 3 mol % as foreign elements to lithium cobalt oxide, at an Li/Co molar ratio ranging from 1.00 to 1.05, wherein charging is conducted when the potential of the positive electrode active material ranges from 4.4 to 4.6 V based on lithium.

The invention having the afore-mentioned constitution provides excellent effects described herein below. Namely that, the first aspect of the invention provides for a non-aqueous electrolyte secondary battery with excellent cycle characteristics and thermal stability, where the potential of the positive electrode active material ranges from 4.4 to 4.6 V based on lithium is achieved by using lithium cobalt oxide to which foreign elements have been added.

In addition, the second aspect of the invention provides for the means of producing the positive electrode active material necessary to easily obtain the effect provided by the first aspect of the invention.

Moreover, according to the third aspect of the invention, since carbonaceous material with a low potential (about 0.1 V based on lithium) is used to form the negative electrode active material, a non-aqueous electrolyte secondary battery having high battery voltage and high utilization rate of the positive electrode active material can be obtained.

Further, according to the fourth aspect of the invention, since the addition of vinylene carbonate (VC), which is customarily used as an additive for suppressing the reductive decomposition of an organic solvent, causes the formation of a negative electrode surface coat (or Solid Electrolyte Interface, which is also referred to as a passivation layer, hereinafter “SEI”) on the negative electrode active material layer before lithium is intercalated to the negative electrode by initial charging, and the SEI functions as a barrier to inhibit the intercalation of solvent molecules in the periphery of lithium ions, the negative electrode active material does not directly react with the organic solvent and, accordingly, the effect of improving the battery's cycle characteristics is achieved as to obtain a non-aqueous electrolyte secondary battery with a longer life. The amount of VC to be added is from 0.5 to 5 mass % but preferably, from 1 to 3 mass % based on the entire electrolyte. Where the amount of VC added is less than 0.5 mass %, the resulting improvement in cycle characteristics is insufficient while on the contrary, if the amount of VC added exceeds 3 mass %, the initial capacity of the battery diminishes and leads to swelling of the battery at high temperature.

Further, according to the fifth aspect of the invention, since the charging voltage can range from 4.4 to 4.6 V based on lithium and is therefore higher than the potential of the usual positive electrode active material based on lithium, it is possible to charge a non-aqueous electrolyte secondary battery with excellent cycle characteristics and margin safety at high capacity and high potential.

### BRIEF DESCRIPTION OF THE DRAWINGS

Preferred embodiments of the present invention will be described in detail with reference to the drawings, wherein FIG. 1 is a perspective view of the vertical cross section of a cylindrical non-aqueous electrolyte secondary battery

FIG. 2 is a schematic view showing the structure of a simple cell.

### DESCRIPTION OF THE PREFERRED EMBODIMENTS

The present invention will be described in more detail with reference to preferred embodiments for executing the invention by citing examples and comparative examples. However, the examples explained below are merely examples of a non-aqueous electrolyte secondary battery and a charging method therefor embodying the technical idea of the invention and are not intended to restrict the applicability of the invention as the invention may be subject of various modifications without departing from the technical idea as shown in the scope of the claims set out herein.

### EXAMPLES 1 TO 11

First, a specific method of manufacturing non-aqueous electrolyte secondary batteries common to Examples 1 to 11 shall be described.

Making of the Positive Electrode

The production of lithium cobalt oxide, to which foreign elements have been added is hereafter described. As starting material, lithium carbonate (Li₂CO₃) is used as lithium source, and zirconium, magnesium, aluminum-added tricobalt tetraoxide (Co₃O₄) are used as sources of cobalt. Zirconium, magnesium, aluminum-added Co₃O₄ is formed by adding solutions of zirconium, magnesium, and aluminum separately dissolved in an acid, to a solution of cobalt likewise dissolved in an acid, then adding sodium hydrogen carbonate thereto to obtain cobalt carbonate upon co-precipitation of zirconium, magnesium, and aluminum, and thermally decomposing the same. Thereafter, the solutions are weighed and upon a determination that the molar ratio between the lithium source and the cobalt source has reached a certain ratio, the solutions are mixed in a mortar and burned for 20 hours in an air atmosphere of 850° C. to obtain zirconium-added lithium cobalt oxide, magnesium-added lithium cobalt oxide, and aluminum-added lithium cobalt oxide. The resulting lithium cobalt oxide are separately pulverized in a mortar to an average grain size of 10 μm to obtain a positive electrode active material.

To prepare a slurry, 85 mass parts of each of the thus obtained positive electrode active substance with a hexagonal system zirconium-added cobalt oxide, magnesium-added cobalt oxide and aluminum-added cobalt oxide, are separately mixed with 10 mass parts of a carbon powder as conductive agent and 5 mass parts of a polyvinylidene fluoride powder as binder, and thereafter mixed with an N-methyl pyrrolidone (NMP) solution. The slurry is then applied on both surfaces of a collector made of aluminum of 20 μm thickness by means of the doctor blade method and dried to form an active material layer on both surfaces of a positive electrode collector. Subsequently, the dried slurry is compressed to 160 μm thickness using a compression roller, thereby resulting in a positive electrode with a length of 55 mm on the shorter side and 500 mm on the longer side.

The amounts of zirconium and aluminum added to the obtained positive electrode active material are analyzed by Inductively Coupled Plasma (ICP) emission spectrometry, while the amount of magnesium added to the obtained positive electrode active material is analyzed by atomic absorption spectrometry. Further, cobalt content is determined by dissolving the positive electrode active material in hydrochloric acid then drying and diluting the same with water and by titration using an ethylene diamine tetra acetic acid (EDTA) standard solution after adding ascorbic acid. On the other hand, lithium content is quantitatively determined by dissolving the positive electrode active material in hydrochloric acid, then drying and diluting the same with water and by flame photometry using a wavelength at 670.8 nm. Then, the Li/Co molar ratio is determined in accordance with the following calculation formula:
Li/Co molar ratio=8.49×Li content(mass %)/Co content(mass %)
Making of the Negative Electrode

To prepare a slurry, 95 mass parts of a natural graphite powder and 5 mass parts of a polyvinylidene fluoride powder are mixed with an NMP solution and the slurry is applied on both surfaces of a copper-made collector to a thickness of 18 μm by means of the doctor blade method and dried to form an active material layer on both surfaces of a negative electrode collector. Subsequently, the dried slurry is compressed to 155 μm using a compression roller, thereby resulting in a negative electrode with a length of 57 mm on the shorter side and 550 mm on the longer side. The potential of graphite is 0.1 V based on lithium.

The amount of the positive electrode and the negative electrode coated is controlled by measuring the charging capacity of the positive electrode active material per 1 g thereof at a charging voltage as the design criterion for a three-electrode type cell (counter electrode: lithium metal, reference electrode: lithium metal), such that the resulting charging capacity ratio (negative pole charging capacity/positive pole charging capacity) is 1.1 based on the obtained data and the theoretical charging capacity of the graphite negative electrode.

Preparation of the Electrolyte

To form an electrolyte for the manufacture of a battery, LiPF₆ is dissolved at the rate of 1 mol/L in a solvent mixture of equal parts of ethylene carbonate and diethyl carbonate.

Manufacture of the Battery

Each of the cylindrical non-aqueous electrolyte secondary batteries (65 mm height, 18 mm diameter) referred to in Examples 1 to 11 were manufactured using the positive electrode, the negative electrode, and the electrolyte described above and a finely porous film made of polypropylene as a separator.

### COMPARATIVE EXAMPLES 1 TO 6

The batteries of Comparative Examples 1 to 6 were manufactured in a manner similar to that of the batteries of Examples 1 to 11 except for variations in the amounts of aluminum, magnesium and zirconium added in the making of the positive electrode as mentioned above.

### COMPARATIVE EXAMPLES 7, 8

The batteries of Comparative Examples 7, 8 were manufactured in a manner similar to that of the batteries of Examples 1 to 11 except for the addition of aluminum by dry mixing immediately before burning and not by co-precipitation in the making of the positive electrode as mentioned above.

### COMPARATIVE EXAMPLES 9, 10

The batteries of Comparative Examples 9, 10 were manufactured in a manner similar to that of the batteries of Examples 1 to 11 except for the addition of magnesium by dry mixing immediately before burning and not by co-precipitation in the making of the positive electrode as mentioned above.

### COMPARATIVE EXAMPLES 11, 12

The batteries of Comparative Examples 11, 12 were manufactured in a manner similar to that of the batteries of Examples 1 to 11 except for the addition of zirconium by dry mixing immediately before burning and not by co-precipitation in the making of the positive electrode as mentioned above.

Measurement of Initial Capacity of the Batteries

Each of the batteries of Examples 1-11 and Comparative Examples 1 to 6 manufactured as described above is initially charged at 25° C. at a constant charging current of 1500 mA until the battery voltage reaches 4.2 V and then at a constant voltage of 4.2 V until the charging current value reaches 30 mA. The initially charged batteries are discharged at 25° C. at a constant current of 1500 mA until the battery voltage reaches 2.75 V and the discharging capacity in this instance is determined as battery initial capacity. The results are arranged pertaining to each of the foreign elements and are respectively shown in Tables 1 to 3.

Thermal Analysis of the Charged Positive Electrode:

Measuring DSC Heat Generation Starting Temperature

After charging them at 25° C. to reach a voltage of 4.2 V at a current value of 100 μA, the batteries of Examples 1 to 11 and Comparative Examples 1 to 12 are decomposed in a dry box, washed with dimethyl carbonate and then dried in vacuum to prepare samples. Ethylene carbonate of 10 mg is added to 40 mg of each sample, sealed in an aluminum cell under an argon atmosphere and temperature is raised by 5° C./min using a differential scanning calorimeter to measure the temperature at which self heating of the battery begins. The results are arranged pertaining to each of the foreign elements and are respectively shown in Tables 1 to 6.

Internal Short Circuit Test in the Charged State

Ten samples of each of the batteries of Examples 1 to 11 and Comparative Examples 1 to 6, 11 and 12 are charged at a constant current of 1500 mA until the battery voltage reaches 4.4 V, and charged thereafter at a constant voltage of 4.4 V until the charging current value reaches 30 mA. Subsequently, each battery is pierced near the center with an iron nail 3 mm in diameter and if the battery is burnt it is adjudged as a failure and disregarded. The number of unburnt batteries is then determined and the corresponding results pertaining to each of the foreign elements are respectively shown in Tables 1 to 3 and Table 6. Since the potential of graphite used for the negative electrode is 0.1 V based on lithium, it was found that if the battery is charged at 4.4 V, the positive electrode potential reaches a high potential state of about 4.5 V based on lithium.

TABLE 1

| | | | | | | Test result |
|---|---|---|---|---|---|---|
| | Amount of | Amount of | Amount of | DSC heat | Initial | of internal |
| | zirconium | magnesium | aluminum | generation | capacity | short |
| | added | added | added | starting | of | circuit in |
| | (molar | (molar | (molar | temperature | battery | the charged |
| | ratio) | ratio) | ratio) | (° C.) | (mAh) | state |
| Comp. | 0.5% | 1.0% | 0% | 185 | 1634 | 8/10 NG |
| Example 1 | | | | | | |
| Example 1 | 0.5% | 1.0% | 0.01% | 191 | 1639 | 10/10 OK |
| Example 2 | 0.5% | 1.0% | 0.5% | 191 | 1635 | 10/10 OK |
| Example 3 | 0.5% | 1.0% | 1.0% | 193 | 1637 | 10/10 OK |
| Example 4 | 0.5% | 1.0% | 2.0% | 194 | 1632 | 10/10 OK |
| Example 5 | 0.5% | 1.0% | 3.0% | 193 | 1630 | 10/10 OK |
| Comp. | 0.5% | 1.0% | 4.0% | 194 | 1611 | 10/10 OK |
| Example 2 | | | | | | |

TABLE 2

| | | | | | | Test result |
|---|---|---|---|---|---|---|
| | Amount of | Amount of | Amount of | DSC heat | Initial | of internal |
| | zirconium | magnesium | aluminum | generation | capacity | short |
| | added | added | added | starting | of | circuit in |
| | (molar | (molar | (molar | temperature | battery | the charged |
| | ratio) | ratio) | ratio) | (° C.) | (mAh) | state |
| Comp. | 0.5% | 0% | 1.0% | 188 | 1634 | 5/10 NG |
| Example 3 | | | | | | |
| Example 6 | 0.5% | 0.01% | 1.0% | 191 | 1636 | 10/10 OK |
| Example 7 | 0.5% | 0.5% | 1.0% | 192 | 1638 | 10/10 OK |
| Example 3 | 0.5% | 1.0% | 1.0% | 193 | 1637 | 10/10 OK |
| Example 8 | 0.5% | 2.0% | 1.0% | 193 | 1640 | 10/10 OK |
| Example 9 | 0.5% | 3.0% | 1.0% | 194 | 1635 | 10/10 OK |
| Comp. | 0.5% | 4.0% | 1.0% | 194 | 1618 | 10/10 OK |
| Example 4 | | | | | | |

TABLE 3

| | | | | | |
|---|---|---|---|---|---|
| | | | | | Test result |
| Amount of | Amount of | Amount of | DSC heat | Initial | of internal |
| zirconium | magnesium | aluminum | generation | capacity | short |
| added | added | added | starting | of | circuit in |
| (molar | (molar | (molar | temperature | battery | the charged |
| ratio) | ratio) | ratio) | (° C.) | (mAh) | state |

| | | | | | | |
|---|---|---|---|---|---|---|
| Comp. | 0% | 1.0% | 1.0% | 192 | 1635 | 8/10 NG |
| Example 5 | | | | | | |
| Example 10 | 0.01% | 1.0% | 1.0% | 193 | 1637 | 10/10 OK |
| Example 3 | 0.5% | 1.0% | 1.0% | 193 | 1637 | 10/10 OK |
| Example 11 | 1.0% | 1.0% | 1.0% | 192 | 1635 | 10/10 OK |
| Comp. | 2.0% | 1.0% | 1.0% | 188 | 1610 | 4/10 NG |
| Example 6 | | | | | | |

TABLE 4

| | Amount of | Amount of | | DSC heat |
|---|---|---|---|---|
| | zirconium | magnesium | | generation |
| | added | added | Amount of | starting |
| | (molar | (molar | aluminum added | temperature |
| | ratio) | ratio) | (molar ratio) | (° C.) |
| Comp. | 0.5% | 1.0% | 0% | 185 |
| Example 1 | | | | |
| Example 1 | 0.5% | 1.0% | 0.01% | 191 |
| | | | (co-precipitative | |
| | | | addition) | |
| Example 5 | 0.5% | 1.0% | 3.0% | 193 |
| | | | (co-precipitative | |
| | | | addition) | |
| Comp. | 0.5% | 1.0% | 0.01% | 184 |
| Example 7 | | | (dry addition) | |
| Comp. | 0.5% | 1.0% | 3.0% | 186 |
| Example 8 | | | (dry addition) | |

TABLE 5

| | Amount of | | | DSC heat |
|---|---|---|---|---|
| | zirconium | | Amount of | generation |
| | added | Amount of | aluminum | starting |
| | (molar | magnesium added | added | temperature |
| | ratio) | (molar ratio) | (molar ratio) | (° C.) |
| Comp. | 0.5% | 0% | 1.0% | 188 |
| Example 3 | | | | |
| Example 6 | 0.5% | 0.01% | 1.0% | 191 |
| | | (co-precipitative | | |
| | | addition) | | |
| Example 9 | 0.5% | 3.0% | 1.0% | 194 |
| | | (co-precipitative | | |
| | | addition) | | |
| Comp. | 0.5% | 0.01% | 1.0% | 188 |
| Example 9 | | (dry addition) | | |
| Comp. | 0.5% | 3.0% | 1.0% | 189 |
| Example 10 | | (dry addition) | | |

TABLE 6

| | | | | | Test result |
|---|---|---|---|---|---|
| | | Amount of | Amount of | DSC heat | of internal |
| | | magnesium | aluminum | generation | short |
| | Amount of | added | added | starting | circuit in |
| | zirconium added | (molar | (molar | temperature | the charged |
| | (molar ratio) | ratio) | ratio) | (° C.) | state |
| Comp. | 0% | 1.0% | 1.0% | 192 | 8/10 NG |
| Example 5 | | | | | |
| Example 10 | 0.01% | 1.0% | 1.0% | 193 | 10/10 OK |
| | (co-precipitative | | | | |
| | addition) | | | | |
| Example 11 | 1.0% | 1.0% | 1.0% | 192 | 10/10 OK |
| | (co-precipitative | | | | |
| | addition) | | | | |
| Comp. | 0.01% | 1.0% | 1.0% | 192 | 9/10 NG |
| Example 11 | (dry addition) | | | | |
| Comp. | 1.0% | 1.0% | 1.0% | 192 | 8/10 NG |
| Example 12 | (dry addition) | | | | |

<Aluminum as Additive>

Based on the results shown in Table 1, the following conclusion can be made if-the amounts of zirconium and magnesium to be added are kept constant at 0.5 mol % and 1.0 mol %, respectively, while modifying the amount of aluminum to be added from 0 mol % to 4.0 mol %. That is, by controlling the amount of aluminum to be added to 0.01 mol % or more, the DSC heat generation starting temperature of the battery increases, leading to improved result of the internal short circuit test in the charged state. However, since initial capacity of the battery diminishes when the amount of aluminum added is 4.0 mol %, the aluminum additive should range from 0.01 mol to 3.0 mol %.

<Magnesium as Additive>

Based on the results shown in Table 2, the following conclusion can be made if the amounts of zirconium and aluminum to be added are kept constant at 0.5 mol % and 1.0 mol %, respectively, while modifying the amount of magnesium to be added from 0 mol % to 4.0 mol %. That is, by controlling the amount of magnesium to be added to 0.01 mol % or more, the DSC heat generation starting temperature of the battery increases, leading to improved result of the internal short circuit test in the charged state. However, since initial capacity of the battery diminishes when the amount of magnesium added is 4.0 mol %, the magnesium additive should range from 0.01 mol to 3.0 mol %.

<Zirconium as Additive>

Based on the results shown in Table 3, the following conclusion can be made if the amounts of magnesium and aluminum to be added are kept constant at 1.0 mol % and 1.0 mol %, respectively, while modifying the amount of zirconium to be added from 0 mol % to 2.0 mol %. That is, by controlling the amount of zirconium to be added to 0.01 mol % or more, the result of the internal short circuit test in the charged state improves. However, since initial capacity of the battery diminishes and there is deterioration in the result of the internal short circuit test when the amount of zirconium added is 2.0 mol %, the zirconium additive should range from 0.01 mol to 1.0 mol %.

<Co-Precipitative Addition of Aluminum>

Based on the results shown in Table 4, the following conclusion can be made if the amount of aluminum added is 0 mol % (Comparative Example 1), 0.01 mol % by co-precipitative addition (Example 1) and by dry addition (Comparative Example 7), and 3.0 mol % by co-precipitative addition (Example 5) and by dry addition (Comparative Example 8), relative to the constant zirconium additive of 0.5 mol % and the constant magnesium additive of 1.0 mol %. That is, in the case of dry addition of aluminum, while the increase in DSC heat generation starting temperature is greater where 3.0 mol % (Comparative Example 8) is added compared to the case where 0.01 mol % (Comparative Example 7) is added, the DSC heat generation starting temperature is lower in both cases, compared to those of Examples 1 and 5 in which aluminum was added upon co-precipitation. Accordingly, from the viewpoint of safety, it can be expected that when the amount of aluminum added exceeds 3.0 mol %, the DSC heat generation starting temperature equal to the case where it is added by co-precipitative addition can be attained. However, considering that aluminum per se does not contribute to electrode reaction and initial capacity of the battery diminishes if more than 3.0 mol % thereof is added, it may be concluded that aluminum should be added upon co-precipitation to obtain the desired effect of an increase in DSC heat generation starting temperature without affecting initial capacity.

<Co-Precipitative Addition of Magnesium>

Based on the results shown in Table 5, the following conclusion can be made if the amount of magnesium added is 0 mol % (comparative Example 3), 0.01 mol % by co-precipitative addition (Example 6) and by dry addition (Comparative Example 9), and 3.0 mol % by co-precipitative addition (Example 9) and by dry addition (Comparative Example 10), relative to the constant zirconium additive of 0.5 mol % and the constant aluminum additive of 1.0 mol %. That is, in the case of dry addition of magnesium, while the increase in DSC heat generation starting temperature is greater where 3.0 mol % (Comparative Example 10) is added compared to the case where 0.01 mol % (Comparative Example 9) is added, the DSC heat generation starting temperature is lower in both cases, compared to those of Examples 6 and 9 in which magnesium was added upon co-precipitation. Accordingly, from the viewpoint of safety, it can be expected that when the amount of magnesium added exceeds 3.0 mol %, the DSC heat generation starting temperature equal to the case where it is added by co-precipitative addition can be attained. However, considering that magnesium per se does not contribute to electrode reaction and initial capacity of the battery diminishes if more than 3.0 mol % thereof is added, it may be concluded that magnesium should be added upon co-precipitation to obtain the desired effect of an increase in DSC heat generation starting temperature without affecting initial capacity.

<Co-Precipitative Addition of Zirconium>

Based on the results shown in Table 6, the following conclusion can be made if the amount of zirconium added is 0 mol % (Comparative Example 5), 0.01 mol % by co-precipitative addition (Example 10) and by dry addition (Comparative Example 11), and 1.0 mol % by co-precipitative addition (Example 11) and by dry addition (Comparative Example 12), relative to the constant magnesium additive of 1.0 mol % and the constant aluminum additive of 1.0 mol %. That is, while the DSC heat generation starting temperature of the batteries in the cases of Example 10 and Example 11 is substantially equal to those of Comparative Example 11 (dry addition of 0.01 mol %) and Comparative Example 12 (dry addition of 1.0 mol %), the internal short circuit performance of the batteries in Example 10 and Example 11 where zirconium was added upon co-precipitation was infinitely better than those of the batteries in Comparative Examples 11 and 12 involving dry addition of zirconium. However, considering that zirconium per se does not contribute to electrode reaction and initial capacity of the battery diminishes if more than 1.0 mol % thereof is added, it may be concluded that zirconium should be added upon co-precipitation to obtain the desired effect of an increase in DSC heat generation starting temperature without affecting initial capacity.

From the results shown in Tables 4 to 6 described above, it can be seen that favorable safety performance can be attained also at a high potential without diminishing the capacity of the battery only when zirconium (ranging from 0.01 to 1.0 mol %), magnesium (ranging from 0.01 to 3.0 mol %), and aluminum (ranging from 0.01 to 3.0 mol %) are added upon co-precipitation.

### EXAMPLES 12, 13 AND COMPARATIVE EXAMPLES 13, 14

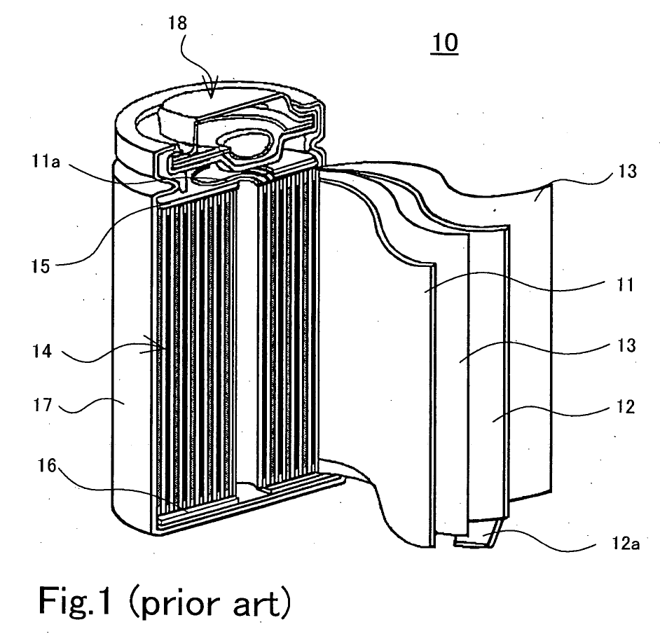

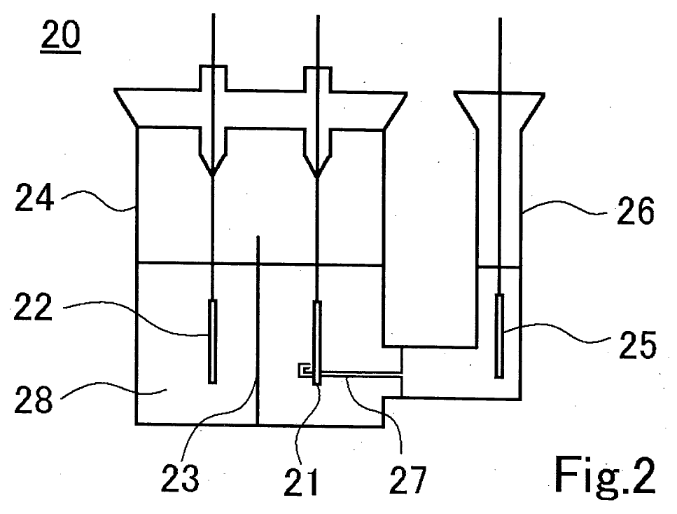

Positive electrodes of Examples 12 and 13 and Comparative Examples 13 and 14 were made in the same manner as that of Example 3 (where the lithium-to-cobalt molar ratio=1.00) except that the lithium-to-cobalt molar ratio was modified to 0.98 in the case of Comparative Example 13, 1.03 in the case of Example 12, 1.05 in the case of Example 13, and 1.06 in the case of Comparative Example 14. Five types of positive electrodes, represented by Examples 12 and 13 and Comparative Examples 13 and 14 and Example 3 were made, each of which were blanked out to 8 cm², and a simple cell 20 of the constitution shown in FIG. 2 was made, in order to conduct simple cell evaluation.

Making of a Positive Electrode Simple Cell

The simple cell 20 comprises a measuring jar 24 in which a positive electrode 21, a counter electrode 22, and a separator 23 are located, and a reference electrode jar 26 in which a reference electrode 25 is located. A capillary tube 27 extends from the reference electrode jar 26 to the vicinity of the surface of the positive electrode 21, and both the measuring jar 24 and reference electrode jar 26 are filled with an electrolyte 28. Lithium metal is used as material for the counter electrode 22, while the material used for the reference electrode 25, the electrolyte 28 and the separator 23 used is identical to that used in Examples 1 to 11. In the following description, all potentials show the potential relative to Li of the reference electrode.

Measurement of the Initial Capacity of the Simple Cell

The simple cell is disposed in a thermostatic bath at 25° C., and the five types of positive electrodes are individually charged at a constant current of 6 mA until the potential at each of the positive electrodes reaches 4.6 V, after which, charging is conducted at a constant voltage of 4.6 V until the final current reaches 0.48 mA. Then, the cell is discharged at a constant current value of 6 mA until the potential at each of the positive electrodes is reduced to 2.75 V, and the initial capacity of each battery is then determined by measuring its discharging capacity at this instance. The results obtained are collectively shown in Table 7.

Measurement of the Cycle Capacity Retaining Rate at 4.3 V

The simple cell is disposed in a thermostatic bath at 25° C., and the five types of positive electrodes are individually charged at a constant current of 6 mA until the potential at each of the positive electrodes reaches 4.3 V, after which, charging is conducted at a constant voltage of 4.3 V until the final current reaches 0.48 mA. Then, the cell is discharged at a constant current value of 6 mA until the potential at each of the positive electrodes is reduced to 2.75 V, and this is then referred to as charge/discharge of the cell at the first cycle. The ratio of the discharging capacity of the cell at the 20th cycle to its discharging capacity at the first cycle is thus determined as the 4.3 V cycle capacity retaining rate for each of the cells. The results obtained are collectively shown in Table 7.

Measurement of the Cycle Capacity Retaining Rate at 4.4 V

The simple cell is disposed in a thermostatic bath at 25° C., and the five types of positive electrodes are individually charged at a constant current of 6 mA until the potential at each of the positive electrodes reaches 4.4 V, after which, charging is conducted at a constant voltage of 4.4 V until the final current of reaches 0.48 mA. Then, the cell is discharged at a constant current value of 6 mA until the potential at each of the positive electrodes is reduced to 2.75 V, and this is then referred to as charge/discharge of the cell at the first cycle. The ratio of the discharging capacity of the cell at the 20th cycle to its discharging capacity at the first cycle is thus determined as the 4.4 V cycle capacity retaining rate for each of the cells. The results obtained are collectively shown in Table 7.

Measurement of the Cycle Capacity Retaining Rate at 4.6 V

The simple cell is disposed in a thermostatic bath at 25° C., and the five types of positive electrodes are individually charged at a constant current of 6 mA until the potential at each of the positive electrodes reaches 4.6 V, after which, charging is conducted at a constant voltage of 4.6 V until the final current reaches 0.48 mA. Then, the cell is discharged at a constant current value of 6 mA until the potential at each of the positive electrodes is reduced to 2.75 V, and this is then referred to as charge/discharge of the cell at the first cycle. The ratio of the discharging capacity of the cell at the 20th cycle to its discharging capacity at the first cycle is thus determined as the 4.6 V cycle capacity retaining rate for each of the cells. The results obtained are collectively shown in Table 7.

TABLE 7

| | Amount of | Amount of | Amount of | | Simple | 4.3 V | 4.4 V | 4.6 V |
|---|---|---|---|---|---|---|---|---|
| | zirconium | magnesium | aluminum | | Cell | cycle | cycle | cycle |
| | added | added | added | Li/Co | initial | capacity | capacity | capacity |
| | (molar | (molar | (molar | molar | capacity | retaining | retaining | retaining |
| | ratio) | ratio) | ratio) | ratio | (mAh) | rate | rate | rate |
| Comp. | 0.5% | 1.0% | 1.0% | 0.98 | 40 | 100% | 100% | 97% |
| Example 13 | | | | | | | | |
| Example 3 | 0.5% | 1.0% | 1.0% | 1.00 | 43 | 100% | 100% | 98% |
| Example 12 | 0.5% | 1.0% | 1.0% | 1.03 | 44 | 100% | 100% | 98% |
| Example 13 | 0.5% | 1.0% | 1.0% | 1.05 | 43 | 100% | 100% | 98% |
| Comp. | 0.5% | 1.0% | 1.0% | 1.06 | 43 | 100% | 98% | 90% |
| Example 14 | | | | | | | | |

<Relationship between Li/Co Molar Ratio and High Potential Performance of the Positive Electrode>

The following can be gleaned from the results shown in Table 7. Comparing the result for Comparative Example 13 with the results for Examples 3, 12, and 13, the initial capacity of the cell is remarkably lower if the Li/Co molar ratio is restricted to less than 1.00. Further, by comparing the result for Comparative Example 14 with the results for Examples 3, 12 and 13 with respect to the cycle capacity retaining rate, it can be derived that the cycle capacity retaining rate at 4.4 V or higher is apparently lower in those cells where the Li/Co molar ratio was controlled beyond 1.05. Accordingly, it can be seen that the Li/Co ratio should be controlled within the range of 1.00 and 1.05 in order that the positive electrode will exhibit favorable discharge capacity as well as charge/discharge cycle performance at a high potential of 4.4 V or more based on lithium.

It is presumed that as foreign elements, zirconium, magnesium, and aluminum have to remain partially solid-solubilized and partially not solid-solubilized within the structure of lithium cobalt oxide in order that the positive electrode active material will exhibit favorable charge/discharge cycle performance at high potential and such solid-solubilized state is attained when the Li/Co ratio is within the range mentioned above. In other words, the phase transition of lithium cobalt oxide is suppressed and its structure is stabilized by reason of the solid solubility of magnesium and aluminum in the structure of lithium cobalt oxide. It is further presumed that due to the addition of zirconium, reaction at the positive electrode-electrolyte interface is ensured to be smooth and the structure of lithium cobalt oxide is likewise stabilized, and such synergistic effects bring about the excellent charge/discharge cycle and safe performance characteristics of the batteries. Further, still, it is presumed that because the additive elements are partially not solidly-solubilized, the vicinity of the surface of the active material remains oxidized, such that elution and deterioration of the surface of the positive electrode active material observed during scanning is suppressed even at high potential and for these reasons excellent characteristics of the battery during the charge/discharge cycle can be maintained at high potential.

From the results described above, it can be said that numerical values for the Li/Co ratio should specifically range from 1.00 to 1.05 in order that the desired effects of adding zirconium, aluminum and magnesium to lithium cobalt oxide can be achieved at high potential.

What is claimed is:

1. A non-aqueous electrolyte secondary battery consisting of a positive electrode comprising a positive electrode active material, a negative electrode comprising a negative electrode active material, and a non-aqueous electrolyte containing a non-aqueous solvent and electrolyte salt, in which
the positive electrode active material comprises a hexagonal system of lithium-containing transition metal composite oxide formed by adding zirconium, magnesium, and aluminum as foreign elements upon synthesis of lithium cobalt oxide, with a zirconium content ranging from 0.01 to 1 mol %, a magnesium content ranging from 0.01 to 3 mol %, and an aluminum content ranging from 0.01 to 3 mol %, and an Li/Co molar ratio ranging from 1.00 to 1.05, and
the potential of the positive electrode active material ranges from 4.4 V to 4.6 V based on lithium.

2. A non-aqueous electrolyte secondary battery according to claim 1, wherein the foreign elements are added by co-precipitation upon synthesis of cobalt carbonate or cobalt hydroxide as starting material for the positive electrode active material.

3. A non-aqueous electrolyte secondary battery according to claim 1, wherein the negative electrode material substance comprises a carbonaceous material.

4. A non-aqueous electrolyte secondary battery according to claim 1, wherein the non-aqueous electrolyte further contains vinylene carbonate ranging from 0.5 to 5 mass %.

5. A method of charging a non-aqueous electrolyte secondary battery consisting of a positive electrode comprising a positive electrode active material, a negative electrode comprising a negative electrode active material, and a non-aqueous electrolyte containing a non-aqueous solvent and electrolyte salt, in which
the positive electrode active material comprises a hexagonal system of lithium-containing transition metal composite oxide formed by adding zirconium, magnesium, and aluminum as foreign elements upon synthesis of lithium cobalt oxide, with a zirconium content ranging from 0.01 to 1 mol %, a magnesium content ranging from 0.01 to 3 mol %, and an aluminum content ranging from 0.01 to 3 mol %, and an Li/Co molar ratio ranging from 1.00 to 1.05, wherein
charging is conducted when the potential of the positive electrode active material ranges from 4.4 to 4.6 V based on lithium.
